(19) United States
(12) Patent Application Publication
(10) Pub. No.: US 2026/0243293 A1
(43) Pub. Date: Aug. 20, 2026

(54) NUT

(71) Applicant: Arno GIEHL, Köln (DE)

(72) Inventor: Arno GIEHL, Köln (DE)

(21) Appl. No.: 19/162,349

(22) PCT Filed: Mar. 7, 2024
(86) PCT No.: PCT/EP2024/056018

§ 371 Date: Sep. 4, 2025

(30) Foreign Application Priority Data
Mar. 15, 2023 (DE) 202023101283.3
Mar. 22, 2023 (DE) 202023101439.9

(51) Int. Cl. F16B 37/08

(52) U.S. Cl. CPC F16B 37/0864

(57) ABSTRACT

The invention relates to a nut with a clamping body, a threaded unit composed of threaded segments, and guide pins. The threaded segments comprise a curved inner surface and are pushed apart by an expansion spring against the force of a clamping body. The threaded unit comprises guide means which guide the threaded segments in the segment receptacle and move the inner surfaces toward each other when the clamping body is pushed on. To protect the expansion spring, the side surfaces of the threaded segments are contoured to constitute a retaining stop for the guide pins in the rear region of the nut in front of the expansion spring. To protect the threads, smooth bolt supports are provided at the edges of the threaded segments.

### CROSS-REFERENCE TO RELATED APPLICATIONS

This application is a National Stage of International Application No. PCT/EP2024/056018, filed Mar. 7, 2024, which claims priority based on German Patent Application Nos. 202023101439.9, filed Mar. 22, 2023 and 202023101283.3, filed Mar. 15, 2023, the entire disclosures of which are incorporated herein by reference.

### TECHNICAL FIELD

Conventional nuts must be screwed onto a threaded bolt and tightened once they reach the stop. In order to avoid having to turn the nut multiple times on longer threaded bolts, or to make it easier to loosen the nut without unscrewing it from the threaded bolt, special nuts have been developed that can be moved along the bolt and engaged with the thread when the desired position is reached. The invention is based on such a known nut according to the generic term of claim 1.

### BACKGROUND

A nut according the preamble of claim 1 is known from WO 01/88390 A1 and is designed to be pushed over a threaded bolt in an axial tightening direction, initially without thread engagement, whereby, after reaching the surface on which the nut will rest after tightening, the nut is brought into a state of thread engagement and can then be tightened like a conventional nut. Segmented nuts are also known from GB 558 302 A and U.S. Pat. No. 5,826,847 A1.

One advantage of the nuts disclosed, in particular the nut disclosed in WO 01/88390 A1, is that by sliding over the external thread of the threaded bolt, time and effort can initially be saved in bringing the nut close to its subsequent holding position without thread engagement, and only then is the internal thread of the nut narrowed to bring the nut into thread engagement, so that it engages with the external thread and the nut can then be tightened like a conventional nut. This means that, for example, only one or a few turns may be necessary to tighten the nut to the desired torque, whereas with a conventional nut, a large number of turns were necessary to move the nut along a long threaded bolt in order to bring it close to its final fixing position.

Another advantage of the nut known from WO 01/88390 A1 is that it can often still be achieved, whereas conventional nuts become rusted fast after prolonged use and are almost impossible to achieve.

To perform the above-mentioned functions, the nut comprises a front section and a rear section relative to the tightening direction, as well as an outer clamping body with an axial segment receptacle that is open on at least one side, first guide means, and guide pins that protrude radially inward. In the disclosed nut, the segment receptacle is embodied as a passage opening in which a threaded unit is held in a manner that allows it to be displaced, in particular slid, at least in the tightening direction.

The threaded unit comprises a first threaded segment and at least one second threaded segment, wherein the first threaded segment and the second threaded segment in turn comprise a curved inner side with sections of threaded pitches and can be assembled to form a segmented internal thread. Of course, the threaded unit can also have three or more threaded segments. In this context, “assembling” means positioning the thread segments in such a way that a thread configuration is created, whereby it is not necessary for the individual thread segments to be in contact with or even connected to each other. It should be sufficient if the thread segments are arranged relative to each other and held individually or together in such a way that a threaded thread, which is usually interrupted at the edges of the thread segments, is formed, which corresponds to the external thread in the manner of a screw/nut connection.

The thread segments are pushed apart by an expansion spring provided in particular in their rear region. Second guide means are provided on the thread unit formed by the thread segments and the expansion spring, which interact with the first guide means in such a way that the first thread segment and the second thread segment are guided in the segment holder. This also causes the curved inner sides of the thread segments to move toward the center axis of the nut and toward each other when the clamping body is pushed onto the thread unit into a closed position, so that the sections of thread pitches constitute the internal thread, i.e., they do not necessarily constitute continuous thread pitches, but are arranged in such a way that they act like a thread. The remaining regions of the thread segments are embodied in such a way that they are spatially recessed and do not interfere with or even block the screwing of an external thread into the internal thread.

In a preferred embodiment, the first thread segment and the second thread segment comprise side surfaces running along the tightening direction. These are the lateral end faces of the thread segments, which are embodied as half-shells, for example, and which face respectively. The guide pins can, for example, protrude into gaps between two opposite side surfaces, whereby it is advantageous if at least one of the side surfaces is contoured in such a way that the side surfaces constitute a stop for the guide pins in the front section, i.e., the gap tapers to such an extent that the guide pins strike the narrowing.

The nut disclosed in WO 01/88390 A1 works very well. It allows the assembly consisting of the clamping body and the threaded unit held in the release position therein to be pushed onto a threaded bolt, the clamping body to be pressed onto the threaded unit with the threaded unit being supported on the abutment surface at which the nut is used, the internal thread to be closed, and the nut to be finally tightened using a conventional wrench.

One disadvantage of the disclosed nuts is that, particularly in the case of larger nominal diameters and therefore heavy nuts, it is difficult to slide them onto a threaded bolt due to the thread segments becoming caught on the external thread of the threaded bolt. In addition, in the event of unintentional snagging of the open nut with the external thread, the guide pin can strike the lower spring abruptly, creating a risk of damage to the spring.

### SUMMARY

### Technical Object

It is the object of the invention to create an improved nut based on the conventional nut, which offers increased comfort when sliding the nut in the release position onto the threaded bolt with a reduced risk of damage to threaded sections. A. further object of the invention is to further develop the nut so that it comprises increased protection against accidental damage and accidental disintegration.

### Technical Solution

According to the invention, this object, in particular the first-mentioned object, is achieved by a nut according to claim 1. A further solution to these objects is provided by a nut according to claim 9.

The new nut is characterized in particular by the fact that the thread segments between the thread segments and the side surfaces comprise smooth recesses on at least one side of the nut, which are free of threads and serve as bolt supports, extending over the entire length of the thread segments from the front section to the rear section, wherein the surface of the thread segments in the region of the recesses is embodied such that the recesses lie completely outside a cylindrical envelope surface in the radial direction, which envelops the outer areas of the thread sections of the internal thread.

In this document, the region of the nut that faces the surface against which the nut then rests when the nut is tightened as intended is marked as the “front region.” The opposite region is then marked as the “rear region.” “Tightening direction” is the direction in which the nut is moved along a threaded bolt when tightened. The term ‘region’ does not only refer to the respective end face or end side of the nut, but also to a section of the nut that extends away from the front or rear end face by up to 30%, preferably up to 20% of the total length in the tightening direction.

### Useful Impacts

The innovations now allow it to be pushed over the threaded bolt much more easily. The recesses create a smooth surface or a linear contact between the spaced thread segments on the external thread of the threaded bolt. This prevents the thread sections of the thread segments from becoming entangled with the external thread at an early stage. It also creates a defined sliding surface on which the nut resting on the external thread can be pushed toward the holding position without risk of damage. The nuts mentioned here can basically be produced in all parameters, in particular, of course, in the standard parameters according to DIN 934 or ISO 4032. The nuts can be made of steel, stainless steel, aluminum, copper, brass, or even plastic.

A mixture of materials is also possible, of course. For example, the threaded segments can be made of steel or stainless steel, while the clamping body can be made of a different material, such as aluminum, brass, or plastic. Very large thread diameters, such as M100 or even much larger, can also be used. If the nuts are made of steel or stainless steel, for example, they have a comparatively high weight with larger thread parameters, which makes it particularly difficult to slide them onto horizontal threaded rods, as the nut must be supported in such a way that the upper parts of the thread sections do not engage with the threads of the external thread.

In the case of plastic nuts, lifting the nuts is easier due to their lower weight, but there is a higher risk that the thread sections will be deformed if they accidentally engage with the threads of the external thread, which can happen in particular if the external thread is made of steel or stainless steel and the nut is made of plastic. The recesses are now designed in such a way that when the thread segments are in the release position, i.e., when the thread unit is pushed out of the clamping body, a smooth contact surface or at least a line-like rail is constituted in the edge area of the thread segments, adjacent to the gap between the side surfaces of the thread segments, on which the external thread can slide off.

Conversely, the thread segments that have been pushed apart rest with their upper, now smooth edge areas on the external thread and can thus be easily moved. The convex embodiment of the cylindrical external thread, as seen from above, keeps the thread segments apart.

In order to also prevent damage caused by the front edge of the thread segments, the front region of the recesses is preferably chamfered or bevelled with a conical segment-like surface inclined forward and outward or with an outwardly rounded surface. The recesses, which together constitute the bolt support, preferably, but not necessarily, comprise a concave curved surface as viewed from the center axis running in the tightening direction.

In the case of a further preferred embodiment of the nut, the surface of the recesses comprises a radius of curvature that is at least of a parameter, but preferably larger than, the radius of curvature of the thread diameter, i.e., the nominal diameter of the nut. This results in an asymptotic contact with the external thread of the threaded bolt. In all cases, the surface of the recesses must protrude outwards to such an extent that the thread sections adjoining the recesses from the perspective of the side surfaces do not come into contact with the inner regions of the threads of the external thread when the thread segments are pushed apart. This means that a slight protrusion of the thread sections into the region of the recesses is not a problem as long as there is sufficient area available to overlap at least two thread sections arranged one behind the other.

However, in an alternative embodiment of the invention, the radius of curvature of the surface may also be smaller than the radius of curvature of a bolt with the nominal diameter of the nut. In this case, a transition edge running parallel to the tightening direction is formed at the edge of the recess in the transition region from the recess to the cylindrically rounded inner region of the remaining region of the inner side of the thread segments. This transition edge can then slide down the external thread like a slide rail. Such an embodiment is particularly suitable for lighter nuts with a smaller thread diameter, where easy handling due to weight is less important than comfortable sliding over the thread.

The recesses may also comprise a completely different shape. In this case, it is advantageous if the surfaces of the recesses have rail-like projections running parallel to the tightening direction as sliding surfaces for sliding the open nut over the external thread of the threaded bolt. Here, it is sufficient if a single sliding surface is provided on each side of the thread segments, i.e., in each recess or at their lateral edge areas. The recesses can be produced during the production of the thread segments by forming or can be milled after the production of the segment body. Ultimately, this will depend on the parameter of the nut and, in particular, on the number of items to be produced.

If the weight to be borne by the sliding surface is greater due to the parameter of the nut or its material, several sliding surfaces may of course also be provided, in particular parallel to each other and preferably also parallel to the tightening direction. However, since the sliding surfaces in all cases only have the function of preventing unintentional engagement with the external thread, they can of course also be helical, in particular in the opposite direction to the external thread.

Finally, the thread segments may comprise a circumferential, radially outwardly protruding shoulder in the front region, additionally or alternatively also in the rear region, which is embodied in such a way that, after the assembled nut has been screwed on, a circumferential or interrupted ring groove is formed between this shoulder and the external thread of the threaded bolt. This recess can be used—in addition to the possibility of inserting a lever into the gap between the side surfaces of the threaded segments—to lever the threaded segments off the bolt in order to achieve the loosening of the nut. In the front region of the nut, the ring groove reduces the contact surface of the nut on the surface against which it is tightened, so that the front region can be designed to be more elastic, which in turn can provide protection against unintentional achieving of the nut.

Another aspect of the invention is that the nut comprises increased security against falling apart and improved protection against damage. This is achieved by a nut that is improved independently of the features described above, in that at least one of the side surfaces is contoured in such a way that opposite side surfaces in the rear region, as viewed from the guide pins in front of the expansion spring, narrow the clear width of the gap in which the guide pins can slide to such an extent below the diameter of the guide pins that this constitutes a securing stop for the guide pins.

The further development of the nut with regard to the securing stop now provides an additional stop located in the rear region of the pushed-together nut. In this rear region, but also behind the additional stop, the spreading means are provided in the form of one or more spreading springs. The spreading means have the object of pushing the threaded segments apart when the clamping body is in the open position. This not only opens the passage opening for the threaded bolt, but also effectively holds the parts of the nut together without the need for additional tongue and groove connections.

In a preferred embodiment of the nut, the threaded unit is not only pushed radially outward by the spring force of the expansion spring, but also moves forward along the threaded bolt or the center axis of the nut. This longitudinal movement results from the guidance of the thread segments on the inside of the clamping body via inclined planes, so that the expansion force of the expansion spring is divided into a radial and an axial component. When the clamping body is achieved, regardless of whether the nut is screwed onto the threaded bolt or not, the threaded segments together with the expansion spring held therein then move forward relative to the clamping body, whereby in the disclosed nuts, the expansion spring moved in this way can strike against the guide pins. This prevents the contouring of the side surfaces and the associated formation of the stop.

In the open position, the threaded segments of the threaded unit guided in the clamping body protrude from the front of the clamping body. Since the clamping body and threaded unit allow radial movement when the clamping body is moved from the closed position to the open position by means of suitable guide means, for example conically widening contact or guide surfaces, the threaded segments can be pushed apart by the spreading means so that the internal thread of the nut disengages from the external thread of the bolt.

On the other hand, pushing the clamping element, which in a preferred embodiment is ring-shaped and has a hexagonal contour for attaching a ring or open-end wrench, causes the thread segments to be pressed inward, resulting in a segmented thread that then engages with the external thread. The spreading means are usually spring means. These can be compression springs provided in the side surfaces of the threaded segments or a ring spring in the rear region of the nut.

In the case of a spreading spring embodied as a ring spring, the additional stop now protects this spreading spring, which previously constituted the stop. Usually, the user pushes the nut in the release position of the clamping body over the threaded bolt until it strikes the surface on which it is to be supported after tightening. The clamping body is then moved further in the direction of this surface until the threaded segments are pressed inward abruptly and the guide pins rest against the stop. This leaves a gap between the clamping body and the surface against which the nut is supported, as it must be ensured that the frictional force securing the nut against achieving can actually be built up between this surface and the threaded unit.

Since the clamping body remains axially movable even when the nut is tightened, it cannot be used to fix the nut in place via a frictional force. In addition, a gap between the clamping body and the surface against which the nut is supported is often desirable, as it can be used to facilitate achieving a loosening of the nut if it is stuck, for example due to rust. In this case, the clamping body can be pushed away from the front areas of the thread segments toward the rear region of the nut using a screwdriver or a wedge, so that the thread segments and the gap between the side surfaces are partially exposed and the thread segments can be achieved radially from the bolt.

The additional stop protects a ring-shaped expansion spring from being damaged when the clamping body is achieved, i.e., when the nut is in the open position. In addition, it is possible that the expansion spring was already damaged beforehand, so that the contoured side surface provides a stop even without the expansion spring. Finally, it is of course also possible to use spring means that are arranged exclusively between the side surfaces but, in contrast to a ring spring, are not circumferential. Such spring means are usually small coil springs that are held in blind holes in the outer surface of the thread segments. Due to their design, these coil springs are not suitable for constituting a stop for the guide pins.

Finally, it is also possible to dispense with an expansion spring altogether. Although the expansion spring then no longer has the advantage of pushing the threaded segments apart when the clamping body is achieved, so that the threaded unit and thus the entire nut, provided it is not rusted fast, can be easily pulled off the threaded bolt, this function can also be achieved by means of guides that allow the threaded segments to move without spring force, solely by means of a guide. Furthermore, it is of course possible to dispense with even these guides, which move the threaded segments outwards when achieved. In this case, there would be no stop, so that the threaded segments could fall out of the clamping body. The guide in the gaps between the side surfaces with an upper and lower stop prevents this.

When the nut is pushed onto a horizontal threaded bolt, the thread segments are pushed apart by the spreading, outward-pressing contact force. In the case of a vertical threaded bolt, the user can create this effect by pressing the nut against the sliding surface as it moves along the threaded bolt. In this way, even without a spreading spring, it is possible to ensure that the thread segments maintain a sufficient distance from the external thread of the threaded bolt and that the nut can be pushed over the external thread in the open position.

Even if the thread segments are stuck to the external thread, the nut can often still be achieved, as mentioned above. To do this, the clamping body is pressed backwards, which, even if it is stuck, can be associated with a jerky loosening after levering or hammering. The user can then insert a spreading tool, for example a screwdriver, into the gap between the thread segments and lever the thread segments away from the external thread to achieve the nut. The locking stop according to the invention now prevents the spreading spring from being damaged by the guide pins protruding on the inside of the clamping body when the clamping body is achieved.

The side surfaces are preferably contoured so that they lie flat opposite each other in the front region of the nut with sections parallel to each other. A gap will remain here, but this only serves to compensate for manufacturing tolerances so that the nut can be securely closed by pushing on the clamping body. This gap can therefore remain small, in particular less than 2 mm, preferably only 1 mm or even smaller. Ultimately, this depends, of course, on the nominal diameter of the nut. However, it is important that the gap is significantly smaller than the diameter of the guide pins so that there is a stop in the front region.

Between the front region of the nut below the above-mentioned stop and the additional safety stop in the rear region of the nut, there is a section in which the side surfaces of the thread segments are largely straight, resulting in a continuous gap in which the guide pins can move back and forth relative to the thread segments during displacement of the clamping body. Since the guide pins are largely non-functional in this region, this gap can have a significantly higher parameter than the thickness of the guide pins.

Towards the rear region of the nut, the gap between the opposite side surfaces of the threaded segments narrows again. Since the threaded segments protrude approximately half their length from the clamping body after the clamping body has been moved to the release position, there is a risk that they will not be held securely enough. This is avoided by the shape of the gap, since the threaded segments are held in flat contact with the inside of the clamping body by the force of the expansion spring via the guide pins in the remaining guide.

Below the longitudinal region, the gap between the side surfaces narrows further, resulting in the locking stop. For this purpose, if present, protruding lugs are provided above the expansion spring in the contour of the side surfaces towards the opposite side surfaces, which, when the clamping body is in the open position, comprise a distance between them that is smaller than the thickness of the guide pins. Since the forces to be absorbed in the region of the locking stop are not as large as in the region of the front stop, the lugs can be made slightly smaller here to create space for the ring groove arranged below the locking stop, in which the expansion spring is held.

Preferably, the nut comprises two thread segments, although three or more thread segments would also be possible, but these would not offer any additional technical benefits in most applications. The threaded unit is composed of the threaded segments assembled circumferentially. In principle, their outer contour, i.e., the outer contour of the threaded segments, can comprise any shape. However, a hexagonal shape in the front region and a cylindrical shape in the rear region of the threaded unit have also proven to be particularly advantageous here.

When two thread segments with a hexagonal outer contour of the thread unit are used, they then comprise three flat surfaces that merge into each other via curved, line-like connecting areas. This results in significant, line-like projections in the region of the curvature, which run parallel to the tightening direction and can be guided in corresponding grooves in the inner surface of the clamping body. These grooves then constitute the first guide means, while the projections constitute the second guide means. This also provides a means of securing the threaded unit against twisting within the clamping body.

Preferably, the thread segments used comprise the same shape. This means that the opposing side surfaces of the thread segments are also basically the same shape but are arranged mirror-inverted to each other. Such thread segments are particularly easy to produce when the threaded unit is constituted by two thread segments, since the two side surfaces of a thread segment comprise planes that are parallel to each other, which can be produced after clamping the blank, for example by machining, without changing tools or the position of the blank. The thread sections do not have to extend over the entire inner surface of the thread segments, whereby the remaining surfaces must of course be set back spatially to such an extent that they do not protrude into the region of the thread.

Depending on the intended purpose of the nut, the segment receptacle may be embodied as a passage opening or, as in the case of a cap nut, may be closed on one side. If the nut is to be pushed onto a longer threaded bolt in order to save the user the trouble of turning the nut over a longer thread pitch, as described above, the segment receptacle must of course be a passage opening. If this aspect is not a priority, the nut can also be embodied similarly to a cap nut. In this case, the clamping body is then closed on the front side, whereby, also like a cap nut, it can comprise a more or less long region into which a protruding thread of the external thread can be inserted.

The part of the nut covering the protruding part of the threaded bolt can also be screwed onto the clamping body or even the threaded bolt itself. In this case, the user can choose to use the nut as a cap nut or as a classic through nut. If the cap region is screwed onto the threaded bolt itself, it can also be used as a locking nut. In this case, it is preferably shaped so that it presses the locking body onto the threaded unit, thereby fixing it in place.

While in the case of a passage opening, the nut will be tightened like a hex nut in most applications and the clamping body comprises a corresponding hexagonal contour for this purpose, in the case of a cap nut, any other shape can of course also be used, so that the surface of the clamping body could also have a recess that allows the use of an Allen key or a comparable tool.

However, all other nuts can also be tightened using the disclosed tools or your own tools designed specifically for this purpose. The only important thing is to be able to apply the required torque. These include, for example, springs, in particular one or more ring springs, or rubber or coil springs arranged in the side surfaces, for example in small blind holes. Spreading means can also be guides, for example guide pins, which are moved along the side surfaces of the threaded segments when the clamping body is displaced, pushing them apart or holding them in guide grooves in the threaded segments. The guide grooves can also be provided in the clamping body on its inner surface in a kinematic reversal, in which case the guide pins can be provided on the threaded segments. In order to achieve the spreading effect, the guide pins can comprise mushroom-shaped end areas that are held in a T-shaped guide groove so that the transverse force can be transmitted. Guiding means are primarily tongue and groove connections, also with a mushroom head connection in a T-shaped groove.

### BRIEF DESCRIPTION OF THE DRAWINGS

Further fields of application and advantages of the invention are apparent from the following description of preferred embodiments with reference to the drawings. It should be understood that the entire description and the description of specific embodiments are for illustrative purposes only and are not intended to limit the scope of the present invention.

The drawings show:

FIG. 1 is a three-dimensional depiction of a nut according to the invention;

FIG. 2 is the threaded unit of the nut from FIG. 1 in a side view;

FIG. 3 is detail “Z” from FIG. 2;

FIG. 4 is the detail “X” from FIG. 1;

FIG. 5 is a thread segment of the nut shown in FIGS. 1 to 4 in a view from the perspective of the thread segment opposite it in the installation position;

FIG. 6 is a threaded bolt with thread segments set to the side without a clamping body in the release position and in a top view;

FIG. 7 is the threaded bolt with the threaded segments from FIG. 6 in the loosened position of the threaded segments,

FIG. 8 is a side view of a further embodiment of the invention, partially in section with the nut in the closed position;

FIG. 9 is the nut shown in FIG. 8 in the open position; and

FIG. 10 is the clamping body of the nut embodiment shown in FIGS. 8 and 9 in a three-dimensional depiction.

### DETAILED DESCRIPTION

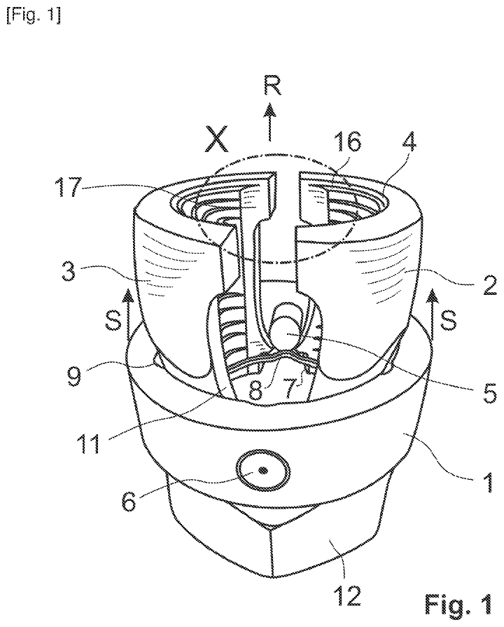

FIG. 1 shows a nut according to the invention in a three-dimensional depiction. The nut comprises a segmented threaded unit, in this case with two threaded segments 2, 3. The threaded segments 2, 3 are pushed apart by an expansion spring 8 from a rear region of the nut (at the bottom of the drawing) relative to the tightening direction R or pressed against the inner surface of a clamping body 1. The clamping body 1 comprises a passage opening as a segment receptacle. In the embodiment shown, the expansion spring 8 is embodied as a ring-shaped bending spring (ring spring) running along the inner surface of the segment receptacle of the clamping body 1 and thus around the outside of the threaded unit.

In the orientation of the thread segments 2, 3 shown in FIG. 1, the internal thread 4 is in an “inactive” state, i.e., the thread segments 2, 3 are pushed apart and cannot interact with an external thread of the thread or nominal diameter of the nut. To transfer the nut to the active state, the clamping body 1 is pushed upwards in a clamping direction S or the threaded unit is pressed into the clamping body 1. This causes the threaded segments 2, 3 to move towards each other and the internal thread 4 assumes its thread or nominal diameter in the closed position.

Guide pins 5, 6 are provided on the inside of the clamping body 1, which protrude into gaps between opposite side surfaces 11 of the thread segments 2, 3. These guide pins 5, 6 interact with stops constituted by the contoured side surfaces 11 in the front and rear regions of the nut or thread unit.

In the lateral region, the threaded segments 2, 3 comprise recesses as bolt supports 17. These bolt supports 17 are constituted by two opposite recesses with a concave curved surface when viewed from the inside of the nut, with this concave area extending continuously from front to rear. FIG. 4 shows detail X from FIG. 1 in an enlarged depiction, in which the concave surface of the recesses forming the bolt support 17 is shown in the upper region of the thread segments 2,3. The guide pins 5, 6 are, of course, only long enough that they do not protrude into the region of the recesses and leave this region free. Otherwise, the guide pins 5, 6 could come into contact with the external thread of the threaded bolt 18 and damage it or negate the desired sliding effect.

In principle, it would be sufficient if such recesses were provided on one side of the nut, opposite each other, respectively on one of the thread segments 2, 3. In this case, in order to obtain the inventive benefit of the sliding surfaces, the user would have to slide the nut onto the threaded bolt 18 in the correct orientation. This, in turn, could of course lead to the user overlooking this and thus the benefit of the invention not being achieved and the nut becoming snagged or one of the threads being damaged in sections. Therefore, it is preferable to provide a recess on both sides of the threaded segments 2, 3 in accordance with the invention to form the bolt support 17.

In the upper region, the threaded segments 2,3 comprise a shoulder 16 that is embodied around the circumference. This results in a groove-shaped gap running around the threaded bolt 18 after the threaded segments 2,3 have been joined together by pushing on the clamping body 1. This can be used to create a defined contact surface for the nut on the surface against which it is tightened. Such a shoulder 16 can also be provided in the rear region of the nut, which could then be used to create an additional option for attaching a tool for levering the threaded segments 2, 3, which have become stuck to the external thread after a certain period of use, away from the external thread.

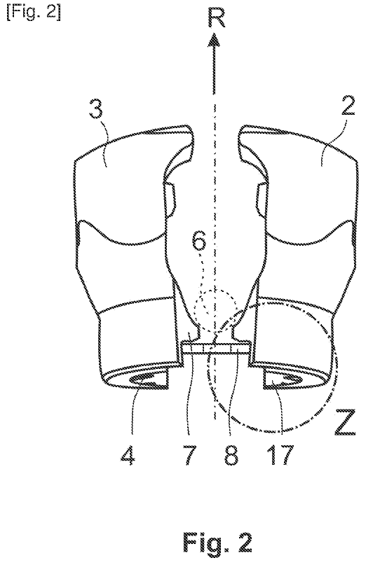

FIG. 2 depicts the threaded unit of the nut from FIG. 1 without the clamping body 1. It can be seen that the side surfaces 11 of the thread segments 2, 3 comprise protruding sections in the upper region which, when viewed from the side, are flat and have flat surfaces facing the respectively other thread segment 3, 2. The upper region in the drawing is the front region of the nut with which the nut is supported against the surface against which it is screwed in the tightening direction R. When the threaded segments 2,3 are assembled or put together to form the threaded unit, these flat surfaces face each other, leaving a small gap, which is smaller than the diameter of the guide pins 5,6. This results in a front stop that becomes effective when the clamping body 1 is pushed onto the threaded segments 2, 3 to close the nut.

A further stop, namely the locking stop 7, is provided in the lower region. This is constituted by two protruding lugs which extend from the side surfaces 11 of the threaded segments 2, 3 in the direction of the opposite threaded segment 3, 2. The expansion spring 8 is arranged below the locking stop 7. The gap between the threaded segments 2,3 can only open by shifting the threaded unit within the clamping body 1 to such an extent that a residual gap remains between the lugs at the narrowest point, which is smaller than the thickness of the guide pins 5,6.

In the embodiment shown, the lugs comprise a rounded surface on their front side facing the nut and thus the guide pins 5, 6, so that it forms a flat contact with the outer surface of the guide pins 5, 6. On the opposite side, the lugs are angular with a contour perpendicular to the tightening direction R, embodied in the shape of the receiving groove 10 for the expansion spring 8, and thus constitute a flat support surface for the expansion spring 8. If the expansion spring 8 does not comprise a flat surface but is made, for example, from a round spring wire, this side of the lug can of course be adapted to the shape of the cross-section of the expansion spring 8 to form the flat contact surface.

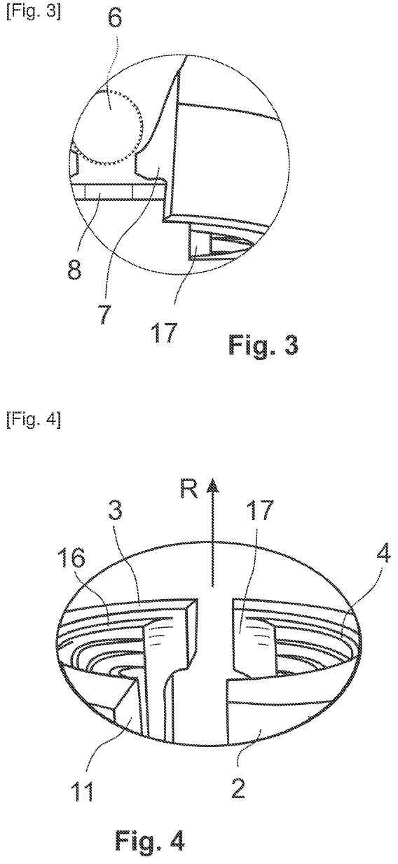

In FIG. 3, the region of the locking stop 7 with the nose of the right-band threaded segment 2 protruding from the side surface 11 is shown in detail Z in an enlarged depiction. Here, the shape of the nose and the contour of the side surface 11 in this lower region can be seen in particular. The nose continues the region of the receiving groove 10 for the annular expansion spring 8, which comprises a rectangular cross-section and can therefore rest flat on the nose if necessary.

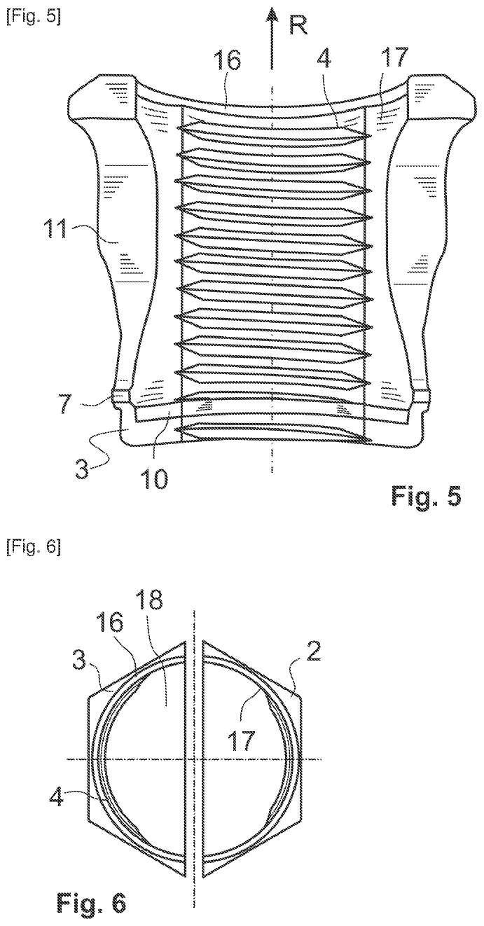

FIG. 5 shows one of the two threaded segments 3 of the nut from FIGS. 1-3. The respectively other threaded segment 2 has the same shape. Since only two threaded segments 2, 3 are used here, the partial surfaces of the side surfaces 11 on both sides of the threaded segment 3 can lie in one plane, which significantly simplifies the production of the threaded segments 2, 3. Between the side surfaces 11 and the thread pitch sections of the internal thread 4, recesses in the form of concave, outwardly oriented, curved surfaces are provided to form a bolt support 17.

A shoulder 16 is provided in the upper region of the threaded segment 3, i.e., an inner region of the shell body of the threaded segment 3 projects inward slightly below the upper edge, into which the thread pitches of the internal thread 4 are incorporated. This allows for a defined run-out of the thread sections and a defined contact surface of the nut against the surface against which it is tightened.

The threads of the internal thread 4 are depicted in the middle region. This internal thread 4 extends here through the receiving groove 10 provided in the lower region to accommodate the expansion spring 8, whereby the receiving groove is so deep that the expansion spring 8 lies outside the region in which the threaded bolt 18 with the external thread is screwed into the nut. Alternatively, the lower region with the receiving groove 10 and the expansion spring 8 can also comprise a larger parameter, so that the expansion spring 8 does not block the thread 4.

Like the guide pins 5, 6, the expansion spring 8 is also embodied, dimensioned, and positioned in such a way that it ideally does not penetrate the region of the recesses of the bolt support 17 or, at least when the bolt support 17 is in contact, can be pushed back by the external thread. However, it is preferable to completely avoid contact between the expansion spring 8 and the external thread of the threaded bolt 18.

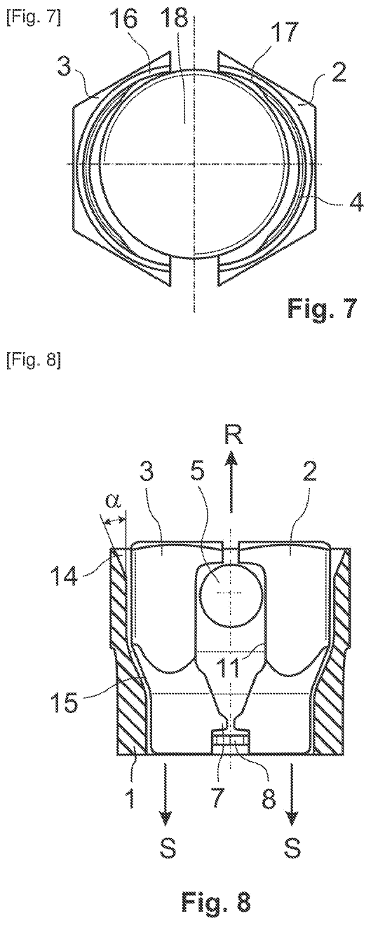

FIGS. 6 and 7 schematically depict the function of a nut according to the invention. For better visibility, the clamping body 1 has not been shown here. FIG. 6 shows the threaded bolt 18 with threaded segments 2, 3 attached to the side. The internal thread 4 engages with the external thread of the threaded bolt 18. A gap remains between the thread segments 2, 3, which widens (not visible here) downwards to form the guide channel for the guide pins 5, 6.

The region with the threaded sections protrudes inward. Recesses are provided in the upper region which, after the threaded segments 2, 3 have been pushed apart, constitute a bolt support 17 without the threaded sections engaging with the external thread of the threaded bolt 18. This position is depicted in FIG. 7. It can be seen that the curvature of the recesses for forming the bolt support 17 is selected so that two linear contact regions are created in the upper region. This allows the nut to be pushed over the external thread while these linear regions are in contact with the external thread without the threads engaging with each other too early. Alternatively, the radius of curvature can of course also be selected so that a flat contact surface is created.

Recesses are also provided in the lower region of the nut so that the user can always press the nut against the external thread with the gap or place it on a horizontal external thread in such a way that one of the gaps visible to the user and thus the bolt support 17 is located in the region of the contact surface. Due in particular to the essentially oval shape of the interior of the open nut, the suitable position is recognizable and, when the nut is lying on a horizontal external thread, the nut will largely turn automatically so that one of the two opposite gaps comes to rest on the support surface. Here, it is of course helpful if a bolt support 17 is provided at both gaps between the thread segments 2, 3, so that it is irrelevant which of the two gaps is at the top.

FIG. 8 shows a further embodiment of the invention. This differs from the variant depicted in FIGS. 1 to 4 in that the thread segments 2,3 comprise segment contact surfaces 15 which, in the open position, i.e. when the clamping body 1 is pulled back from the thread unit as far as it is possible due to its guided coupling with the threaded unit, it rests on inner support surfaces 14 of the clamping body 1. First of all, it can be seen that the basic function is similar to the embodiment depicted in FIGS. 1 to 4. The clamping body 1, depicted in section with hatching, can be moved back and forth relative to the threaded unit, which is also constituted here by two identical threaded segments 2, 3, by a defined distance in a release direction L and a closing direction S. This path is limited by the guide pins 5, 6, as well as by an upper stop in the closing direction S and a lower safety stop 7 in the loosening direction L. Here, too, a ring spring is provided below the safety stop 7 as an expansion spring 8.

To open the nut, the threaded unit is pushed or pressed in the release direction L (upwards in the orientation shown). This allows for the expansion spring 8 to push the threaded segments 2,3 outwards within the expanding region of the clamping body 1. For this purpose, the inner surface of the clamping body 1 is stepped, as is the outer surface of the threaded unit. The radial outward and upward movement of the threaded segments 2,3 displaces the upper region of the threaded segments 2,3 out of the interior of the through bore of the annular clamping body 1. To ensure that the threaded unit remains as dimensionally stable as possible despite being opened, the threaded segments 2, 3, which are pressed radially outward, now make flat contact with the upper edge of the clamping body 1.

For the flat contact surface, the upper edge of the inner surface of the through-hole of the clamping body 1 is flattened outwards in sections. These flattened regions, referred to as support surfaces 14, are embodied in this case, although a curved surface is also possible for these regions. The only essential feature is the corresponding segment contact surface 15, which lies as flat as possible against the support surface 14.

In the embodiment shown, the threaded unit comprises a hexagonal shape after the threaded segments 2, 3 have been assembled to form the segmented threaded unit. The rounded edges of this outer shape are guided in guide grooves 9 of the segment holder of the clamping body 1. These guide grooves 9 are not absolutely necessary, but they secure the threaded unit against twisting and thus also prevent the guide pins 5, 6 from being pressed against the side surfaces 11 of the threaded segments 2, 3 when a torque is applied to the clamping body 1.

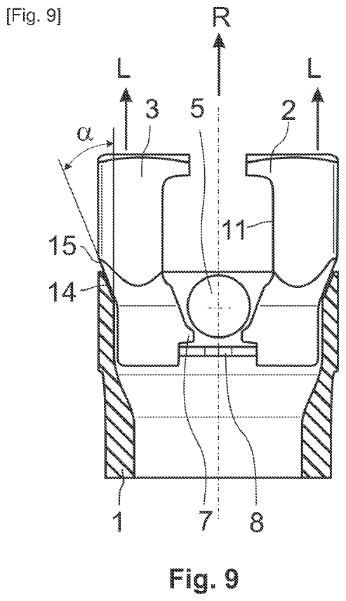

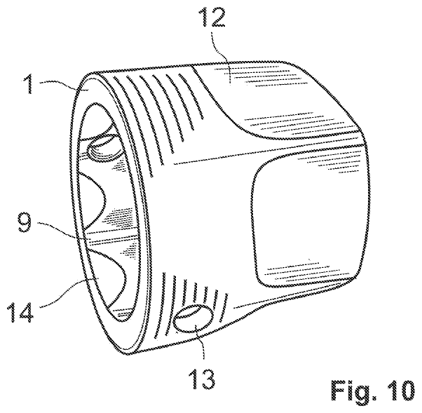

FIG. 10 shows the clamping body 1 of the embodiment according to FIG. 8 or FIG. 9 in a three-dimensional depiction. It can be seen that the clamping body 1 comprises a hexagonal shape at its region 12, like a conventional nut, so that a standard open-end or ring spanner can be used. The segment holder, which is not visible here, allows a longer threaded bolt 18 to be passed through the nut. If, of course, the length of the threaded bolt 18 is adapted to the height of the nut and it is not necessary for the threaded bolt 18 to protrude from the nut in the front region, as is the case with a cap nut, for example, the clamping body 1 can also be closed at the top like a cap nut.

FIG. 10 illustrates the position of the support surfaces 14 for the segment contact surfaces 15. FIGS. 5 and 6 show that the support surfaces 14 are inclined outward at an angle a. The angle a is preferably in a region between 20° and 40°. The region between 25° and 35° has proven to be particularly practical, with an angle α of 28° being preferred. If the threaded segments 2, 3 are now moved from the closed position shown in FIG. 8, in which the threaded segments 2, 3 are moved downwards in the closing direction S, into the direction opposite to the closing direction S to achieve release, the threaded segments 2, 3 move laterally outwards until the stepped region with the segment contact surfaces 15 is supported on the support surfaces 14.

The clamping body 1 according to FIG. 10 comprises pin receptacles 13 for receiving the guide pins 5, 6 as passage openings, which could also be embodied as blind holes on the inside of the outer surface. In the embodiment shown here, the guide pins 5, 6 are pressed into the pin receptacles 13 so that they are held firmly in place there. Alternatively, the guide pins 5, 6 could also be screwed into the pin receptacles 13. For this purpose, a corresponding thread pairing is provided on the guide pins 5, 6 and the pin receptacle 13.

The expansion spring 8 presses the thread segments 2, 3 outwards, so that the thread segments 2, 3 are held securely in place, which creates a high-quality impression, but also ensures that the thread segments 2, 3 are kept at a distance from the external thread during movement of the nut, so that the nut can be pushed onto the threaded bolt 18 with a reduced risk of the segments of the internal thread 4 becoming entangled with the external thread.

As in the embodiment shown in FIGS. 1 to 4, the threaded unit in the embodiment shown here also comprises an external hexagonal shape in the front region. Although this is not absolutely necessary, it has proven to be a preferred variant. This front region transitions into a cylindrical rear region with a reduced diameter. The segment contact surfaces 15 are embodied in the transition region between these regions, which are produced here by milling the conical transition region that tapers toward the rear and inward, or by shaping the surfaces in another way. The latter can be produced for larger quantities, for example, by forging or stamping.

The embodiment shown in FIGS. 5 to 7 thus comprises two steps in the region of the clamping body 1. A first step is located in the middle region and, when the thread segments 2, 3 are moved in the closing direction S in conjunction with the inverted stepped region of the thread unit, causes the thread unit to close. The second step is located in the front region of the clamping body 1, extending to the outer edge. This in turn creates the flat contact via the support surfaces 14 and the segment contact surfaces 15.

Of course, the two corresponding surfaces, namely the support surface 14 and the segment contact surface 15, can also be embodied as a circumferential, inclined, smooth, or curved arc. Ultimately, the only essential aspect of the invention is that the middle region of the threaded segments 2,3 makes contact with the upper edge region or even with an end region of the clamping body 1 located slightly below this.

To secure the nut against unintentional achieving, the clamping body 1 may also comprise one or more locking pins which can be pressed into openings, for example blind holes, in the outer side of the threaded segments 2, 3. Alternatively, the outer side of the threaded segments 2,3 can also be embodied in sections at right angles to the tightening direction R, so that missing locking elements, which can be arranged on the inner contour of the clamping body 1, can be supported on the steps.

This embodiment can be embodied such that the clamping body 1 can only be achieved from the compressed, segmented threaded unit in a destructive manner, for example by destroying the locking elements during detachment. The locking elements and the stepped region can also be embodied as plastic components, resulting in an elastic securing region which, however, can be easily overcome by applying the appropriate force, destroying the plastic parts as sacrificial components. The plastic components can then preferably also be replaceable in order to make the nut ready for use again after achieving.

Finally, the clamping body 1 can also be screwed onto the threaded segments 2, 3 in the clamping direction S. For this purpose, it will usually be advisable to first position the threaded segments 2, 3 on the external thread in the manner described above or in some other way and only then to screw the clamping body 1 onto the threaded unit with a few turning movements. Here too, locking pins or the stepped locking options for pawls described above can prevent the clamping body 1 from accidentally achieving looseness from the threaded unit.

Of course, both the threaded unit and, if screwed onto it, the clamping body 1 can be designed as conventional screws as actively secured or self-locking screw connections.

Where the term “approximately” is used in this document, it indicates a tolerance range that is considered normal by a person skilled in the art. In particular, the term “approximately” is to be understood as a tolerance range of up to plus or minus 20 percent, preferably up to plus or minus 10 percent. Features described in connection with an embodiment or the description of the figures may also be implemented independently of other features of these embodiments or of the features shown in the figures and may be the subject of an independent invention.

It is understood that the description and specific examples are for illustrative purposes only and are not intended to limit the scope of the present invention.

### INDUSTRIAL APPLICABILITY

The invention relates to the production and use of novel nuts for use in all regions of technology.

### TABLE OF REFERENCES

1 Clamping body
2 First threaded segment
3 Second threaded segment
4 Internal thread
5 First guide pin
6 Second guide pin
7 Locking stop
8 Expansion spring
9 Guide groove
10 Receiving groove
11 Side surface
12 Hexagonal outer contour
13 Pin receptacle
14 Support surface for the segment contact surface
15 Segment contact surface
16 Heel
17 Bolt support
18 Threaded bolt
α Angle between support surface and tightening direction
R Tightening direction of nut
L Loosening direction of clamping body
S Clamping direction of clamping body

1. A nut for screwing onto a threaded bolt in an axial tightening direction (R), with a front section and a rear section, respectively relative to the tightening direction (R), and with
a clamping body with a segment holder that is open on at least one side, first guide means, and guide pins that protrude radially inward,
a threaded unit that can be moved back and forth in the segment receptacle at least in the tightening direction (R), which comprises at least two thread segments with curved inner sides having thread pitches, wherein the thread segments can be assembled to form a segmented internal thread with thread segments adjacent to or spaced apart from each other,
second guide means provided on the threaded unit, which interact with the first guide means in such a way that the thread segments are guided in the segment receptacle and, when the clamping body is moved relative to the threaded unit in the tightening direction (R), the curved inner sides are moved toward each other in such a way that the thread sections constitute the segmented internal thread, wherein
the threaded segments comprise side surfaces extending along both sides in the tightening direction (R), and the guide pins protrude into gaps between opposite side surfaces and at least one of the side surfaces (11) is contoured in such a way that the side surfaces in the front section of the nut constitute a stop for the guide pins characterized in that
the threaded segments comprise smooth recesses free of threads on at least one side between the threaded segments and the side surfaces to form a smooth bolt support which extends over the entire length of the threaded segments from the front section to the rear section, wherein the surface of the threaded segments is embodied in the region of the recesses such that the recesses lie completely outside a cylindrical envelope surface in the radial direction, which envelops the outer areas of the thread sections of the internal thread.

2. The nut according to claim 1, characterized in that the recesses forming the bolt support comprise a concave curved surface as viewed from the center axis running in the tightening direction (R).

3. The nut according to claim 2, characterized in that the surface comprises a radius of curvature that is at least of a parameter, preferably larger than the radius of curvature of a nominal diameter of the nut.

4. The nut according to claim 2, characterized in that the surface comprises a radius of curvature that is smaller than the radius of curvature of a nominal diameter of the nut.

5. The nut according to claim 1, characterized in that the surfaces of the recesses have rail-like projections running parallel to the tightening direction (R) rail-like projections that comprise sliding surfaces for pushing the opened nut over the external thread of the threaded bolt, which are located completely outside a cylindrical envelope surface that envelops the outer regions of the thread pitch sections of the internal thread.

6. The nut according to claim 1, characterized in that the threaded segments in the front region and/or rear region comprise a circumferential, radially outwardly projecting shoulder which is embodied in such a way that, after the assembled nut has been screwed on, a groove is formed between the shoulder and the external thread of the threaded bolt.

7. The nut according to claim 1, characterized in that the front region of the recesses is chamfered or completely beveled.

8. The nut according to claim 1, characterized in that the threaded segments are provided with recesses on both sides, so that when the threaded segments in the release position, a bolt support is formed on each of two opposite sides of the nut, which is respectively constituted by recesses, arranged on both sides of the gap in which the guide pins are guided, wherein the guide pins are embodied such that they are located completely outside the bolt support.

9. A nut for screwing onto a threaded bolt in an axial tightening direction (R), with a front section and a rear section, respectively relative to the tightening direction (R), and with
a clamping body with a segment receptacle open on at least one side, first guide means, and guide pins projecting radially inward,
a threaded unit that can be moved back and forth in the segment receptacle at least in the tightening direction (R), which comprises at least two threaded segments with curved inner sides having thread sections, wherein the threaded segments can be assembled to form a segmented internal thread with threaded segments adjacent to or spaced apart from each other,
second guide means provided on the threaded unit, which interact with the first guide means in such a way that the threaded segments are guided in the segment receptacle and, when the clamping body is moved relative to the threaded unit in the tightening direction (R), the curved inner sides are moved toward each other in such a way that the thread sections constitute the segmented internal thread,
wherein the threaded segments comprise side surfaces extending on both sides along the tightening direction (R) and the guide pins protrude into gaps between opposite side surfaces and at least one of the side surfaces is contoured in such a way that the side surfaces in the front section of the nut constitute a stop for the guide pins characterized in that
at least one of the side surfaces is contoured in such a way that the side surfaces in the rear section of the nut constitute a retaining stop for the guide pins

10. The nut according to claim 9, chracterized in that the threaded unit comprises at least one expansion spring arranged in particular in the rear section, which exerts a radial expansion force on the threaded segments wherein, viewed from the guide pins the locking stop is arranged in front of the expansion spring.

11. The nut according to claim 9, characterized in that the side surfaces of at least one threaded segment in the front region of the nut comprise a flat section which is arranged at right angles to the tightening direction (R) and whose smooth surface runs parallel to the tightening direction (R) and to the adjacent side surface.

12. The nut according to claim 9, characterized in that the opposite side surfaces of the threaded segments in the front region of the nut respectively comprise a section that protrudes in the direction of the adjacent thread segment, wherein the protruding sections together constitute the front stop for the guide pin.

13. The nut according to claim 9, characterized in that the opposite side surfaces of the threaded segments in the rear region of the nut respectively comprise a section that protrudes toward the adjacent threaded segment with the protruding sections together constituting the rear stop for the guide pins.

14. The nut according to claim 13, characterized in that the side surfaces of the threaded segments comprise the same basic shape, so that the side surfaces of each threaded segment facing each other are mirrored to each other and comprise a straight section between the upper stop and the rear locking stop that runs parallel to the tightening direction (R).

15. The nut according to claim 9, characterized in that, in the region of the upper stop, when the clamping body is pushed completely onto the threaded unit, a gap of less than 2 mm, preferably 1 mm or less, remains.

16. The nut according to claim 9, characterized in that the inner surface of the clamping body forms part of the first guide means in sections as a sliding surface, and the second guide means comprise the outer surface of the assembled threaded segments as a sliding surface in sections.

17. The nut according to claim 16, characterized in that the first threaded segment and the second threaded segment have segment contact surfaces on their outer side in the end region facing the rear region of the nut, which are beveled radially outwards from rear to front by an angle (α), and the inner surface of the clamping body in the end region facing the front region of the nut, which interact with the segment contact surfaces in such a way that, when the threaded segments in a loosening direction (L), the segment contact surfaces, held by the spreading force of the spreading spring, are supported flat on the beveled support surfaces.

18. The nut according to claim 17, characterized in that the segment contact surfaces of the threaded segments and the beveled support surfaces of the clamping body are flat surfaces, wherein the thread unit with the assembled threaded segments has a hexagonal outer shape, particularly in the front region, outer shape and a rearward transition to a rear cylindrical region that comprises a smaller outer diameter than the front region, and the segment contact surfaces are constituted by surfaces beveled by the angle (α) in the transition region from the outer surfaces of the front region forming the hexagon to the rear region.

19. The nut according to claim 9, characterized in that the threaded unit comprises exactly two threaded segments with identical shapes and the outer side of the threaded segments facing the clamping body comprises three flat sections merging into one another, which run parallel to the tightening direction (R), so that the assembled threaded segments have a shape that is similar to that of the clamping body facing the clamping body comprises three flat sections merging into one another via curvature areas running parallel to the tightening direction (R), so that the assembled threaded segments comprise the shape of a hexagon screw.

20. The nut according to claim 19, characterized in that the inner surface of the clamping body has guide grooves running parallel to the tightening direction (R) as additional guides for the first guide means, wherein the curved areas of the threaded segments are guided in the guide grooves in such a way that they are secured against twisting.

21. The nut according to claim 9, characterized in that the clamping body comprises a hexagonal outer contour for attaching a spanner or ring spanner.

22. The nut according to claim 9, characterized in that the expansion spring is a ring spring which is arranged in a receiving groove formed by a recess in the inner contour of the threaded segments.

23. The nut according to claim 9, characterized in that the rear retaining stop for the guide pins is constituted by sections protruding from the side surfaces in the direction of the opposite side surfaces, which are arranged above the receiving groove.
